(19) United States
(12) Patent Application Publication
(10) Pub. No.: US 2018/0136599 A1
(43) Pub. Date: May 17, 2018

(54) DECURLER, SHEET FINISHER AND IMAGE FORMING APPARATUS

(71) Applicant: KONICA MINOLTA, INC., Tokyo (JP)

(72) Inventor: Tsuyoshi SHIOKAWA, Tokyo (JP)

(21) Appl. No.: 15/812,259

(22) Filed: Nov. 14, 2017

(30) Foreign Application Priority Data
Nov. 14, 2016 (JP) 2016-221163

(51) Int. Cl. G03G 15/00

(52) U.S. Cl. CPC G03G 15/6576

(57) ABSTRACT

A decurler includes: a drive roller; a driven roller which rotates to follow the drive roller; an endless belt wound around the drive roller and the driven roller; and a pushing roller pushed into an outer peripheral surface of the endless belt. Curl formed of a sheet is corrected by passing the sheet between the endless belt and the pushing roller. The decurler further comprises: a guide member which guides the sheet to the endless belt; and a regulating member located in an inner peripheral side of the endless belt to hold, within a correcting force effective area, the endless belt deformed by the sheet guided by the guide member. The regulating member determines a relative positional relationship between the endless belt and the pushing roller based on the position of the pushing roller and the form of the endless belt deformed by a sheet.

### CROSS REFERENCE TO RELATED APPLICATION

The present invention claims priority under 35 U.S.C. § 119 to Japanese Application No. 2016-221163 filed Nov. 14, 2016, the entire content of which is incorporated herein by reference.

### BACKGROUND

### Technical Field

The present invention relates to a decurler, a sheet finisher and an image forming apparatus.

### Description of the Related Art

Generally speaking, an image forming apparatus based on an electrophotographic process charges photoreceptor drums, writes electrostatic latent images on the drums, and visualizes the electrostatic latent image to form toner images by attaching toner to the electrostatic latent image. The toner images formed on the photoreceptor drums are transferred to a sheet, and then heated and pressed by a fixing nip. Thereby, depending upon the condition of a sheet and an environment in which the sheet is conveyed, the sheet may be curled. Then, there are a variety of apparatuses proposed for correcting curl of a sheet (for example, refer to Japanese Unexamined Patent Application Publication No. 2009-007079, Japanese Unexamined Patent Application Publication No. 2016-060564 and Japanese Unexamined Patent Application Publication No. 2016-128345).

### SUMMARY

However, the prior art technique as described in these Publications is only to pass a sheet through a nip which is formed by pressing a various roller or the like against a belt for correcting curl of the sheet. Accordingly, even if the power of correcting curl of a sheet is increased by increasing the pushing amount of the various roller or the like, it may be impossible to maintain a balance between the rigidity of a belt and the paper density of the sheet. In accordance with the above prior art techniques, unless a balance between the rigidity of a belt and the paper density of a sheet is maintained, the power of correcting curl of a sheet is not increased in accordance with the pushing amount of the various roller even by increasing the pushing amount of the various roller or the like.

Taking into consideration the above circumstances, it is an object of the present invention therefore to provide a decurler, a sheet finisher and an image forming apparatus, in which the power of correcting curl of a sheet can be increased.

To achieve at least one of the abovementioned objects, according to one aspect of the present invention, a decurler comprises: a drive roller; a driven roller which rotates to follow rotation of the drive roller; an endless belt which is wound around the drive roller and the driven roller; and a pushing roller which is pushed into an outer peripheral surface of the endless belt, wherein curl formed of a sheet is corrected by passing the sheet between the endless belt and the pushing roller. The decurler further comprises: a guide member which guides the sheet to the endless belt; and a regulating member located in an inner peripheral side of the endless belt to hold, within a correcting force effective area, the endless belt which is deformed by the sheet which is guided by the guide member, wherein the regulating member determines a relative positional relationship between the endless belt and the pushing roller based on the position of the pushing roller and the form of the endless belt which is deformed by a sheet.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic view for showing an example of the overall configuration of an image forming system 1 in accordance with an embodiment 1 of the present invention.

FIG. 2 is a schematic diagram for showing a main architecture of a control system of an image forming apparatus 2 in accordance with the embodiment 1.

FIG. 3 is a schematic diagram for showing a main architecture of a control system of a sheet finisher 7 in accordance with the embodiment 1.

FIG. 4 is a view for briefly explaining the structure of a decurler 700 in accordance with the embodiment 1 of the present invention.

FIG. 5 is a view for briefly explaining the structure of the decurler 700 in accordance with an embodiment 2 of the present invention.

FIG. 6 is a view for briefly explaining the structure of the decurler 700 in accordance with an embodiment 3 of the present invention.

FIG. 7 is a view for briefly explaining the structure of the decurler 700 in accordance with an embodiment 4 of the present invention.

FIG. 8 is a view for briefly explaining the structure of the decurler 700 in accordance with an embodiment 5 of the present invention.

FIG. 9 is a view for briefly explaining the structure of the decurler 700 in accordance with an embodiment 6 of the present invention.

FIG. 10 is a view for briefly explaining the structure of the decurler 700 in accordance with an embodiment 7 of the present invention.

FIG. 11 is a view for briefly explaining the structure of the decurler 700 in accordance with an embodiment 8 of the present invention.

FIG. 12 is a view for briefly explaining the structure of the decurler 700 in accordance with an embodiment 9 of the present invention.

FIG. 13 is a view for briefly explaining the structure of the decurler 700 in accordance with an embodiment 10 of the present invention.

FIG. 14 is a view for briefly explaining the structure of the decurler 700 in accordance with an embodiment 11 of the present invention.

FIG. 15 is a view for briefly explaining the structure of the decurler 700 in accordance with an embodiment 12 of the present invention.

FIG. 16 is a view for briefly explaining the structure of the decurler 700 in accordance with an embodiment 13 of the present invention.

FIG. 17 is a view for briefly explaining the structure of the decurler 700 in accordance with an embodiment 14 of the present invention.

FIG. 18 is a view for briefly explaining the structure of the decurler 700 in accordance with an embodiment 15 of the present invention.

FIG. 19 is a view for briefly explaining the structure of the decurler 700 in accordance with an embodiment 16 of the present invention.

FIG. 20 is a view for briefly explaining the situation in which a sheet S rushes into an endless belt 713 at a rush-in angle α of no smaller than 90° in the decurler 700 in accordance with an embodiment 17 of the present invention.

FIG. 21 is a view for briefly explaining the situation in which a sheet S rushes into the endless belt 713 at a rush-in angle α of smaller than 90° in the decurler 700 in accordance with the embodiment 17 of the present invention.

FIG. 22 is a view for briefly explaining the structure of the decurler 700 in accordance with an embodiment 18 of the present invention.

FIG. 23 is a view for briefly explaining another structure of the decurler 700 in accordance with the embodiment 18 of the present invention.

FIG. 24 is a view for briefly explaining the structure of a decurler 700′ in accordance with a prior art.

FIG. 25 is a view for briefly explaining an example of partial deformation of the endless belt 713 in the decurler 700′ of the prior art.

FIG. 26 is a view for briefly explaining an example of partial deviation of the endless belt 713 from a correcting force effective area Z in the downstream side of a pushing roller 716 along the conveying direction B of a sheet S.

### DETAILED DESCRIPTION OF EMBODIMENTS

Hereinafter, one or more embodiments of the present invention will be described with reference to the drawings. However, the scope of the invention is not limited to the disclosed embodiments.

### Embodiment 1

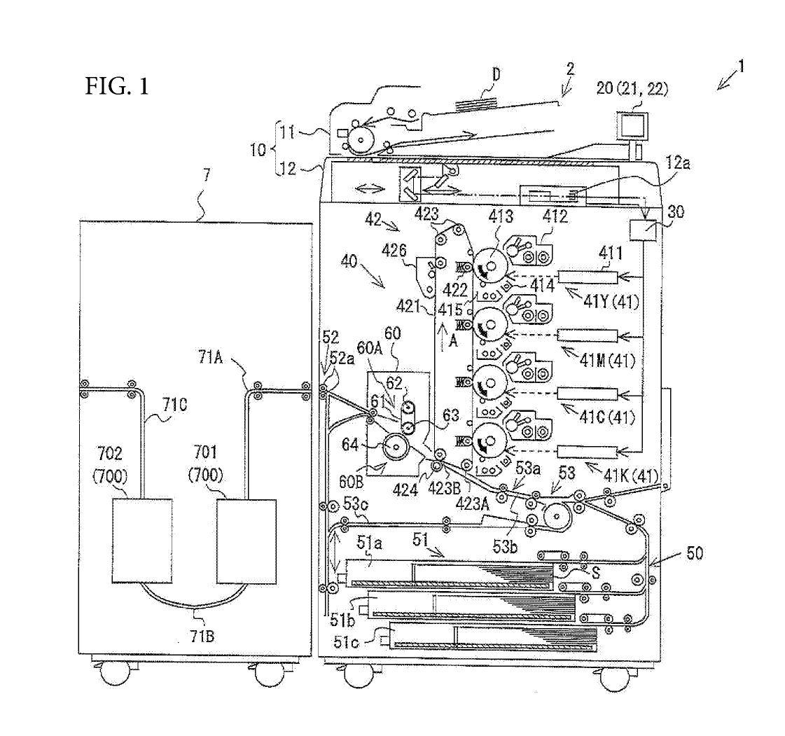

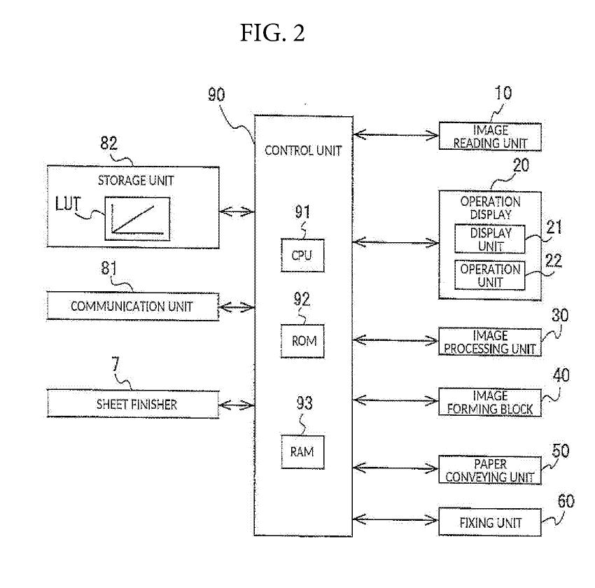

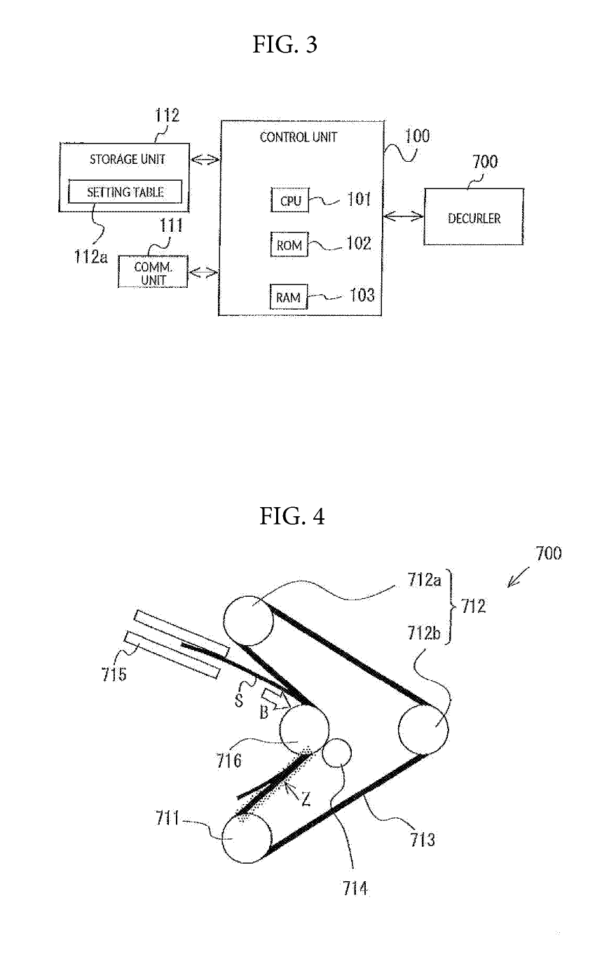

FIG. 1 is a schematic view for showing an example of the overall configuration of an image forming system 1 in accordance with an embodiment 1 of the present invention. FIG. 2 is a schematic diagram for showing a main architecture of a control system of an image forming apparatus 2 in accordance with the embodiment 1. FIG. 3 is a schematic diagram for showing a main architecture of a control system of a sheet finisher 7 in accordance with the embodiment 1.

As illustrated in FIG. 1, the image forming system 1 includes the image forming apparatus 2 and the sheet finisher 7 The image forming apparatus 2 and the sheet finisher 7 are connected in order that the image forming apparatus 2 is located in the upstream side with respect to conveyance of a sheet S, and that the sheet finisher 7 is located in the downstream side with respect to conveyance of a sheet S.

The image forming apparatus 2 is an apparatus which forms a color image on a sheet S by an intermediate transfer system based on an electrophotographic process technique. As described below in detail, the image forming apparatus 2 transfers toner images of respective colors, i.e., color Y (yellow), color M (Magenta), color C (cyan) and color K (black) formed on photoreceptor drums 413 to the intermediate transfer belt 421 as a first transfer process. The respective color toner images transferred to the intermediate transfer belt 421 are superimposed and transferred to a sheet S as a second transfer process to form an image on the sheet S.

The image forming apparatus 2 is based on a tandem system. The tandem system is a system in which the photoreceptor drums 413 corresponding to the four colors YMCK are arranged in series in the running direction of the intermediate transfer belt 421 so that a toner image of each color is successively transferred to the intermediate transfer belt 421 in one step.

Specifically, the image forming apparatus 2 is provided with an image reading unit 10, an operation display 20, an image processing unit 30, an image forming block 40, a paper conveying unit 50, a fixing unit 60 and a control unit 90.

As illustrated in FIG. 2, the control unit 90 is provided with a CPU 91, a ROM 92 and a RAM 93. The CPU 91 reads a program from the ROM 92 in accordance with a required process, loads the program into the RAM 93, and executes the loaded program to control the operation of the image forming apparatus 2 in cooperation. The storage unit 82 consists of a nonvolatile semiconductor device such as a flash memory or the like or a hard disk drive for storing various data. The various data stored in the storage unit 82 is referred to when the CPU 91 controls the operation of the image forming apparatus 2.

The control unit 90 performs, through the communication unit 81, transmission to and reception from an external device which is connected to a LAN, a WAN or the like communication network. For example, the control unit 90 receives image data transmitted from the external apparatus, and transfers a command to form an image on a sheet S to the image processing unit 30 based on the received image data. The communication unit 81 consists, for example, of a communication control card such as a LAN card.

As illustrated in FIG. 3, the control unit 100 is provided with a CPU 101, a ROM 102 and a RAM 103. The CPU 101 reads a program from the ROM 102 in accordance with a required process, loads the program into the RAM 103, and executes the loaded program to control the operation of the sheet finisher 7 in cooperation. The storage unit 112 consists of a nonvolatile semiconductor device such as a flash memory or the like or a hard disk drive for storing various data. The various data stored in the storage unit 112 is referred to when the CPU 101 controls the operation of the sheet finisher 7. For example, the storage unit 112 is used to store a setting table 112a. The setting table 112a contains several parameters which are used to control a decurler 700.

The control unit 100 performs, through the communication unit 111, transmission to and reception from an external device which is connected to a LAN, a WAN or the like communication network. For example, the control unit 100 receives various data transmitted from the external apparatus, and transfers a command to correct curl of a sheet S to the decurler 700 based on the received various data. The communication unit 111 consists, for example, of a communication control card such as a LAN card.

Incidentally, the control unit 90 performs transmission and reception of various data with the sheet finisher 7 through the communication unit 81. For example, the control unit 90 transfers information about the curl state of a sheet S to the sheet finisher 7. The information about the curl state of a sheet S is information about factors relating to formation of curl, for example, the paper density and paper type of the sheet S, the environment around the image forming apparatus 2, the fixing temperature of the fixing unit 60 and the like. Accordingly, the sheet finisher 7 can correct curl of a sheet S based on various data transmitted from the control unit 90. Incidentally, the information about the curl state of a sheet S may be directly set in the storage unit 112 by a user.

Referring to FIG. 1 again, the operation display 20 is implemented with a liquid crystal display (LCD: Liquid Crystal Display) incorporating a touch panel, and serves as a display unit 21 and an operation unit 22. The display unit 21 displays a various operation screen, the condition of an image, the operation state of each function and the like in accordance with a display control signal which is input from the control unit 90. The operation unit 22 is provided with various operation keys such as a ten keyboard, a start key and so forth. The operation unit 22 accepts various input operations from a user and generates operation signals. The operation signals are output to the control unit 90.

The image reading unit 10 is provided with an automatic page feeding unit 11 and an original image scanner device 12. The automatic page feeding unit 11 is called an ADF (Auto Document Feeder). The automatic page feeding unit 11 conveys originals D, which are placed on an original tray, by a conveyance mechanism and transfers the originals D to the original image scanner device 12. The automatic page feeding unit 11 can successively read a number of originals D placed on the original tray. Meanwhile, when successively reading a number of originals D, the automatic page feeding unit 11 can read the opposite sides of each original D by a sheet reversing mechanism.

The original image scanner device 12 optically scans an original D conveyed to a contact glass from the automatic page feeding unit 11 or an original D placed on the contact glass. The original image scanner device 12 reads an original image formed on an original D by causing a reflected light from the original D to form an image on a light receiving plane of a CCD sensor 12a during optical scanning. The image reading unit 10 generates input image data of the original image based on the reading result of the original image scanner device 12. The input image data is supplied to the image processing unit 30 which performs a predetermined image process with the input image data.

The image processing unit 30 is provided with a circuit which performs a digital image process with the input image data in accordance with initial settings or user settings. The image processing unit 30 performs, for example, gradation level adjustment of the input image data under control of the control unit 90 based on a gradation level adjustment table in which gradation level adjustment data is set up. In addition to the gradation level adjustment, the image processing unit 30 also performs other processes with the input image data such as color correction, shading compensation and other various correction processes, and compression processes. The image forming block 40 performs various processes with the input image data after performing such various digital image processes.

The image formation block 40 forms an image based on the input image data with colored toners corresponding to a Y component, an M component, a C component and a K component respectively. The image forming block 40 is provided with image forming units 41Y, 41M, 41C and 41K, [symbol] an intermediate transfer unit 42 and the like.

The image forming units 41Y, 41M, 41C and 41K are composed of the same constituent elements except they forms images of different colors respectively. For the sake of clarity in explanation and illustration, while like numerals denote similar elements, suffixes Y, M, C and K is added to the ends of the numerals respectively for distinguishing from each other, but no suffix is added when they need not be distinguished. In the case of the example as shown in FIG. 1, only the constituent elements of the image forming unit 41Y for component Y are given reference numerals, but reference numerals are omitted for the constituent elements of the other image forming units 41M, 41C and 41K.

The image forming unit 41 is provided with an exposing device 411, a development apparatus 412, a photoreceptor drum 413, a charging unit 414, a drum cleaning unit 415 and the like.

The photoreceptor drum 413 is formed of a negative electrification type organic photo-conductor (OPC: Organic Photo-Conductor) and has a photoconductivity. The photoreceptor drum 413 consists, for example, of a conductive cylinder such as an aluminum blank tube on which are successively stacked an under coat layer (UCL layer), a charge generation layer (CGL layer), and a charge transport layer (CTL layer).

The charging unit 414 generates corona discharge. The surface of the charge transport layer of the photoreceptor drum 413 is uniformly charged with negative charge by the corona discharge of the charging unit 414, and therefore the surface charge of the charge transport layer of the photoreceptor drum 413 is negative.

The exposing device 411 is provided with a constituent element for radiating laser light such as a semiconductor laser. The exposing device 411 irradiates the photoreceptor drum 413 with laser light corresponding to the image of each color component. Positive charge is generated in the charge generation layer of the photoreceptor drum 413 by laser irradiation to the photoreceptor drum 413 from the exposing device 411. The positive charge in the charge generation layer of the photoreceptor drum 413 is transported to the charge transport layer of the photoreceptor drum 413. Accordingly, the exposing device 411 irradiates the photoreceptor drum 413 with laser light to generate positive charge which is transported to the charge transport layer to neutralize the surface charge of the charge transport layer of the photoreceptor drum 413 which is uniformly charged with negative charge by the charging unit 414. An electrostatic latent image corresponding to each color component is thereby formed by the differential potential between the surface portions irradiated with laser light of the surface of the photoreceptor drum 413 and the other surface portions charged with negative charge.

The development apparatus 412 performs development based on a two-component reverse process by the use of a developing agent consisting of a toner and a carrier. The development apparatus 412 supplies the photoreceptor drum 413 with toner corresponding to each color contained in the developing agent. The development apparatus 412 forms a toner image by attaching a toner of each color component to the surface of the photoreceptor drum 413 to visualize an electrostatic latent image.

The drum cleaning unit 415 is provided with a drum cleaning blade and the like. The drum cleaning blade removes transfer residual toner which remains on the surface of the photoreceptor drum 413 after a first transfer process.

The intermediate transfer unit 42 is provided with an intermediate transfer belt 421, a first transfer roller 422, a plurality of support rollers 423, a second transfer roller 424, a belt cleaning unit 426 and the like.

The intermediate transfer belt 421 is made of an endless belt which is conductive and elastic with a high resistant layer formed on the surface thereof. The intermediate transfer belt 421 is wound around the plurality of support rollers 423 with tension applied to the intermediate transfer belt 421. Of the plurality of support rollers 423, at least one roller is a drive roller 423A, and the other rollers are driven by the drive roller 423A. Accordingly, the drive roller 423A rotates to run the intermediate transfer belt 421 at a predetermined speed in

A direction. Incidentally, of the plurality of support rollers 423 driven by the drive roller 423A, the roller located in the downstream side of the drive roller 423A along the running direction of the intermediate transfer belt 421 serves as a backup roller 423B.

The first transfer roller 422 is located opposite to the photoreceptor drum 413 of each color component in the inner peripheral surface side of the intermediate transfer belt 421. Accordingly, a first transfer nip is formed by urging the first transfer rollers 422 against the photoreceptor drum 413 with the intermediate transfer belt 421 therebetween. The first transfer nip serves to transfer a toner image from the photoreceptor drum 413 to the intermediate transfer belt 421.

The second transfer roller 424 is located opposite to the backup roller 423B in the outer peripheral surface side of the intermediate transfer belt 421. Accordingly, a second transfer nip is formed by urging the second transfer rollers 424 against the backup roller 423B with the intermediate transfer belt 421 therebetween. The second transfer nip transfers a toner image from the intermediate transfer belt 421 to a sheet S.

The belt cleaning unit 426 removes transfer residual toner which remains on the surface of the intermediate transfer belt 421 after a second transfer process.

Specifically, when the intermediate transfer belt 421 is passed through the first transfer nip, toner images are successively transferred to the intermediate transfer belt 421 from the photoreceptor drum 413 and superimposed on the intermediate transfer belt 421 respectively as a first transfer process. More specifically, a first transfer bias voltage is applied to the first transfer roller 422 in order to charge the rear surface of the intermediate transfer belt 421, i.e., the surface which contacts the first transfer roller 422, with electricity of the polarity opposite to that of toner which forms a toner image. Accordingly, the toner images of the photoreceptor drums 413 are electrostatically transferred to the intermediate transfer belt 421.

When a sheet S is passed through the second transfer nip, the toner images transferred to the intermediate transfer belt 421 are transferred to the sheet S as a second transfer process. Specifically, a second transfer bias voltage is applied to the backup roller 423B in order to charge the surface of the backup roller 423B opposite to the front surface of the sheet S, i.e., the surface which contacts the intermediate transfer belt 421, with electricity of the same polarity as toner which forms a toner image. Accordingly, the toner images of the intermediate transfer belt 421 are electrostatically transferred to the sheet S.

The fixing unit 60 includes an upper fixing unit 60A and a lower fixing unit 60B. The upper fixing unit 60A is located in the fixing side of a sheet S and provided with a fixing side member. A toner image has been transferred to the fixing side of a sheet S. The lower fixing unit 60B is located opposite to the fixing side of a sheet S, and provided with a back side support member. The opposite side to the fixing side of a sheet S is the back side of the sheet S. A fixing nip is formed by bringing the back side support member into press-contact with the fixing side member. While supported between these member, a sheet S is conveyed through the fixing nip.

Specifically, the upper fixing unit 60A includes a fixing belt 61, a heat roller 62 and a fixing roller 63 as the fixing side members. The fixing belt 61 is made of an endless belt which is wound around the heat roller 62 and the fixing roller 63 with tension applied to the fixing belt 61. The heat roller 62 incorporates a heat source such as a halogen heater to heat the fixing belt 61. The fixing roller 63 is driven to rotate in the clockwise direction to drive the fixing belt 61 and the heat roller 62 in the clockwise direction.

The lower fixing unit 60B is provided with a pressure roller 64 as the back side support member. The fixing nip as explained above is formed between the pressure roller 64 and the fixing belt 61. The pressure roller 64 is driven to rotate in the counter clockwise direction.

The paper conveying unit 50 includes a paper feed unit 51, a sheet discharger 52 and a conveyance route section 53. The paper feed unit 51 includes paper feed tray units 51a to 51c. The paper feed tray units 51a to 51c accommodates sheets S which are classified based on paper densities and sizes of sheets and separately stored in accordance with predetermined sheet types respectively.

The conveyance route section 53 includes a normal conveying route 53b and a reverse conveying route 53c. The normal conveying route 53b is provided for conveying a sheet S supplied from the paper feed unit 51 to conveying roller pairs including a paper stop roller pair 53a, the image forming block 40 and the fixing unit 60 respectively, and discharging the sheet S to the sheet finisher 7 which is located outside the image forming apparatus 2. The reverse conveying route 53c is arranged to reverse the front and back sides of a sheet S passed through the fixing unit 60 and join again with the normal conveying route 53b in the upstream side of the image forming block 40. For example, when performing a double-side printing process of a sheet S, first, a toner image is formed on the front side of a sheet S by passing the sheet S through the normal conveying route 53b. Next, the front and back sides of the sheet S is reversed by passing the sheet S through the reverse conveying route 53c. Next, the reversed sheet S is conveyed from the reverse conveying route 53c and passed through the normal conveying route 53b in which a toner image is formed on the back side of the sheet S.

Incidentally, sheets S stored in each of the paper feed tray units 51a to 51c are fed out from the uppermost sheet one by one, and conveyed to the image formation block 40 through the conveyance passage section 53. While conveying a sheet S to the image forming block 40, the paper stop roller pair 53a corrects the inclination of the sheet S and adjusts the timing of conveying the sheet S. The image forming block 40 secondly transfers the toner images of the intermediate transfer belt 421 in a lump to one side of a sheet S which is conveyed from the paper stop roller pair 53a. The fixing unit 60 fixes the toner images secondly transferred in a lump from the intermediate transfer belt 421 to the sheet S. After fixing the images by the fixing unit 60, the sheet S is discharged outwards by the sheet discharger 52. Specifically, the sheet discharger 52 is provided with a discharging roller 52a which conveys the sheet S with the images printed thereon to the sheet finisher 7.

The sheet S discharged from the image forming apparatus 2 is conveyed to the sheet finisher 7. The sheet finisher 7 is provided with a conveyance unit 71A, a conveyance unit 71B, a conveyance unit 71C, a decurler 701, a decurler 702 and the like. Incidentally, the decurler 701 and the decurler 702 are collectively referred to simply as the decurler 700 when they need not be distinguished.

The conveyance unit 71A receives a sheet S discharged from the image forming apparatus 2 and conveys the sheet S to the decurler 701. The decurler 701 corrects, in a convex form, curl formed on a first side of the front and back sides of a sheet S, on which an image is formed, immediately before discharging the sheet S from the image forming apparatus 2. The conveyance unit 71B provides a route through which a sheet S is conveyed from the decurler 701 to the decurler 702. The decurler 702 corrects, in a convex form, a second side opposite to the first side of the front and back sides of a sheet S. The conveyance unit 71C provides a route through which a sheet S passed through the decurler 702 is discharged outwards from the sheet finisher 7.

Incidentally, since curl formed of a sheet S is in a curved shape, the decurler 700 can apply a correcting force for correcting the curl to the sheet S by deforming the sheet S in a convex form.

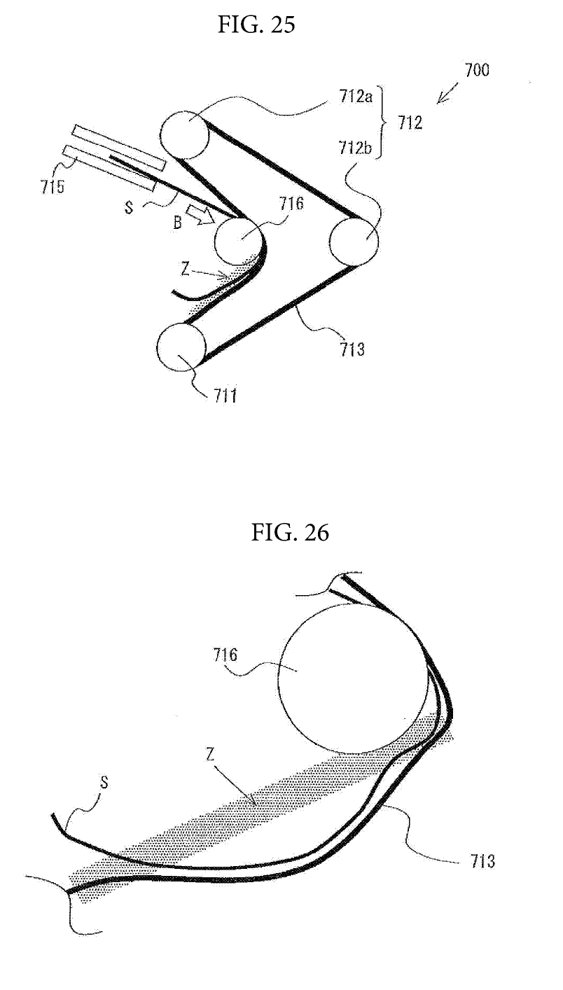

FIG. 4 is a view for briefly explaining the structure of the decurler 700 in accordance with the embodiment 1 of the present invention. FIG. 24 is a view for briefly explaining the structure of the decurler 700′ in accordance with a prior art. FIG. 25 is a view for briefly explaining an example of partial deformation of an endless belt 713 in the decurler 700′ of the prior art. FIG. 26 is a view for briefly explaining an example of partial deviation of the endless belt 713 from a correcting force effective area Z in the downstream side of a pushing roller 716 along the conveying direction B of a sheet S.

As illustrated in FIG. 4, the decurler 700 is provided with a drive roller 711, driven rollers 712a and 712b, an endless belt 713 and a pushing roller 716. The drive roller 711 is a roller which rotates to drive other members. The driven rollers 712a and 712b are rollers which rotates following the rotation of the drive roller 711. Incidentally, the driven rollers 712a and 712b are collectively referred to simply as the driven roller 712 when they need not be distinguished.

The endless belt 713 is made of an endless belt which is wound around the drive roller 711 and the driven rollers 712. The pushing roller 716 is arranged to push the outer peripheral surface of the endless belt 713. The decurler 700 corrects curl formed of a sheet S by passing the sheet S between the endless belt 713 and the pushing roller 716.

Specifically, the decurler 700 forms a nip on the endless belt 713 by pushing the pushing roller 716 against the endless belt 713. The decurler 700 can correct curl of a sheet S by passing the sheet S through the nip.

Meanwhile, the decurler 700 is provided with a guide member 715. The guide member 715 guides a sheet S to the endless belt 713. The guide member 715 adjusts the rush-in angle α of a sheet S at which the sheet S rushes into the endless belt 713 by adjusting the angle of the sheet S relative to the endless belt 713 in accordance with a control command from the control unit 100.

More specifically, passing a sheet S through the nip formed between the endless belt 713 and the pushing roller 716 corresponds to passing the sheet S through a curved passage formed between the endless belt 713 and the pushing roller 716. When a sheet S is passed through the curved passage formed between the endless belt 713 and the pushing roller 716, a force is applied to the sheet S in a convex form so that curl of the sheet S can be corrected. Incidentally, it is not preferred that the rigidity of the endless belt 713 is low in order to deform the endless belt 713 in a convex form.

However, if the rigidity of the endless belt 713 is low, it may become difficult to maintain the balance between the rigidity of the endless belt 713 and the paper density of the sheet S when the pushing amount of the pushing roller 716 is increased to increase the force of correcting curl. For example, when curl of a sheet S is corrected by the prior art decurler 700 shown in FIG. 24, there is a fear that the endless belt 713 deviates from the correcting force effective area Z as illustrated in FIGS. 25 and 26.

In other words, unless the balance between the rigidity of the endless belt 713 and the paper density of a sheet S can be maintained, even if the pushing amount of the pushing roller 716 is increased, the force of correcting the sheet S is not increased corresponding to the increment of the pushing amount of the pushing roller 716 so that it is impossible to increase the force of correcting curl of the sheet S.

The decurler 700 is thereby provided with a regulating member 714. The regulating member 714 is located in the inner peripheral surface side of the endless belt 713 and serves to hold, within the correcting force effective area Z, the endless belt 713 which is deformed by a sheet S which is guided by the guide member 715.

Specifically, the regulating member 714 determines the relative positional relationship between the endless belt 713 and the pushing roller 716 based on the position of the pushing roller 716 and the form of the endless belt 713 which is deformed by a sheet S. The relative positional relationship between the endless belt 713 and the pushing roller 716 is changed with the regulating member 714 in accordance with the rush-in angle α of a sheet S which is guided by the guide member 715.

Also, the regulating member 714 holds, within the correcting force effective area Z, a portion of the endless belt 713 which is located in the downstream side of the pushing roller 716 along the conveying direction B of a sheet S.

As described above, the regulating member 714 determines the relative positional relationship between the endless belt 713 and the pushing roller 716 based on the position of the pushing roller 716 and the form of the endless belt 713 to hold the endless belt 713 within the correcting force effective area Z.

Accordingly, even when the pushing amount of the pushing roller 716 is increased so that the balance between the rigidity of the endless belt 713 and the paper density of a sheet S cannot be maintained, the regulating member 714 keeps the endless belt 713 within the correcting force effective area Z. The endless belt 713 is thereby not deformed by the stiffness of a sheet S. Also, as the pushing amount of the pushing roller 716 increases, it is possible to increase the area of a sheet S which is wound around the endless belt 713. As a result, the sheet S can be formed in a desired shape so that the force of correcting curl of the sheet S can be increased.

Furthermore, the relative positional relationship between the endless belt 713 and the pushing roller 716 is changed with the regulating member 714 in accordance with the rush-in angle α of a sheet S. Accordingly, from whichever angle α sheet S rushes into the endless belt 713, the regulating member 714 can be arranged at a position of the endless belt 713 which is deformed. The regulating member 714 can thereby hold the endless belt 713 in an appropriate position.

Also, when a sheet S rushes into the endless belt 713, depending upon the stiffness of the sheet S, the endless belt 713 is deformed particularly in the downstream side of the pushing roller 716 along the conveying direction B of the sheet S. If the endless belt 713 is deformed, the endless belt 713 is separated from the pushing roller 716 so that a sheet S cannot be formed in a desired shape.

From this fact, the regulating member 714 is provided for holding the deformation of the endless belt 713 within the correcting force effective area Z in the downstream side of the pushing roller 716 along the conveying direction B of the sheet S so that it is possible to provide the force of correcting curl in accordance with the pushing amount of the regulating member 714.

### Embodiment 2

In this embodiment 2, similar elements are given similar references as in the embodiment 1, and therefore no redundant description is repeated. The embodiment 2 is described to more specifically explain the location of the regulating member 714 than in the embodiment 1.

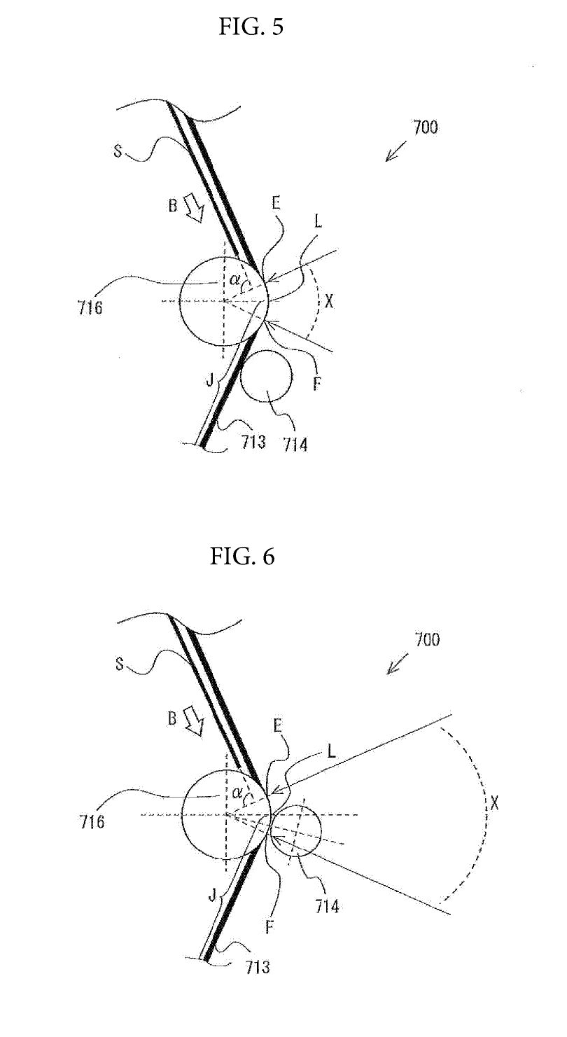

FIG. 5 is a view for briefly explaining the structure of the decurler 700 in accordance with the embodiment 2 of the present invention. As illustrated in FIG. 5, the rush-in angle α of a sheet S corresponds to the angle between the conveying direction B of the sheet S and the direction perpendicular to the contact point in the upstream side along the conveying direction B of the sheet S among the contact points between the pushing roller 716 and the endless belt 713.

A most downstream position F is a position in which the pushing roller 716 makes contact with the endless belt 713 in the most downstream point along the conveying direction B of a sheet S among the contact points between the pushing roller 716 and the endless belt 713. A most upstream position E is a position in which the pushing roller 716 makes contact with the endless belt 713 in the most upstream point along the conveying direction B of a sheet S among the contact points between the pushing roller 716 and the endless belt 713. A reference position L is a position corresponding to a midpoint between the most downstream position F and the most upstream position E. A winding area X is an area where part of the endless belt 713 is wound around the curved surface of the pushing roller 716, i.e., a contact area therebetween.

As illustrated in FIG. 5, in the case where a sheet S is guided by the guide member 715 in order that the rush-in angle α is no smaller than 90°, the regulating member 714 is arranged in a downstream area J including contact points located in the downstream side of the reference position L along the conveying direction B of the sheet S among the contact points between the pushing roller 716 and the endless belt 713.

As has been discussed above, if the rush-in angle α of a sheet S is known, the deformation of the endless belt 713 by the sheet S can be estimated so that the rush-in angle α of the sheet S can be associated with the location of the endless belt 713 where deformation occurs.

Namely, it is possible to determine the positional relationship among the pushing roller 716, a sheet S and the endless belt 713 with reference to the rush-in angle α of the sheet S. Accordingly, the regulating member 714 can be arranged in an appropriate position in accordance with the rush-in angle α of a sheet S.

Also, even if there is the possibility that the endless belt 713 is deformed by a sheet S in the downstream side thereof, the regulating member 714 can inhibit the endless belt 713 in advance from being deformed in the downstream side by arranging the regulating member 714 in the upstream side of the position in which the regulating member 714 supports the endless belt 713 along in the conveying direction B of the sheet S.

### Embodiment 3

In this embodiment 3, similar elements are given similar references as in the embodiment 1 and the embodiment 2, and therefore no redundant description is repeated. In accordance with the embodiment 3, explanation is directed to an example in which the location of the regulating member 714 is more limited than in the embodiments 1 and 2.

FIG. 6 is a view for briefly explaining the structure of the decurler 700 in accordance with the embodiment 3 of the present invention. As illustrated in FIG. 6, in the case where a sheet S is guided by the guide member 715 in order that the rush-in angle α is no smaller than 90°, the regulating member 714 is arranged in an area where the downstream area J and the winding area X overlap.

Accordingly, the endless belt 713 is inhibited from being deformed by a sheet S in an area in the upstream side of the position in which the regulating member 714 makes contact with the endless belt 713 along the conveying direction B of the sheet S. The position in which the regulating member 714 makes contact with the endless belt 713 falls in an area where the downstream area J and the winding area X overlap. The winding area X is an area where part of the endless belt 713 is wound around the pushing roller 716. Accordingly, the endless belt 713 is inhibited from being deformed by a sheet S in the upstream side of part of a winding area X along the conveying direction B of the sheet S.

Thus, even when the pushing amount of the pushing roller 716 is increased, the force of correcting curl of the sheet S can be increased in the upstream side of the position in which the regulating member 714 makes contact with the endless belt 713.

### Embodiment 4

In this embodiment 4, similar elements are given similar references as in the embodiments 1 through 3, and therefore no redundant description is repeated. In accordance with the embodiment 3, explanation is directed to an example in which the location of the regulating member 714 is more limited than in the embodiments 1 through 3.

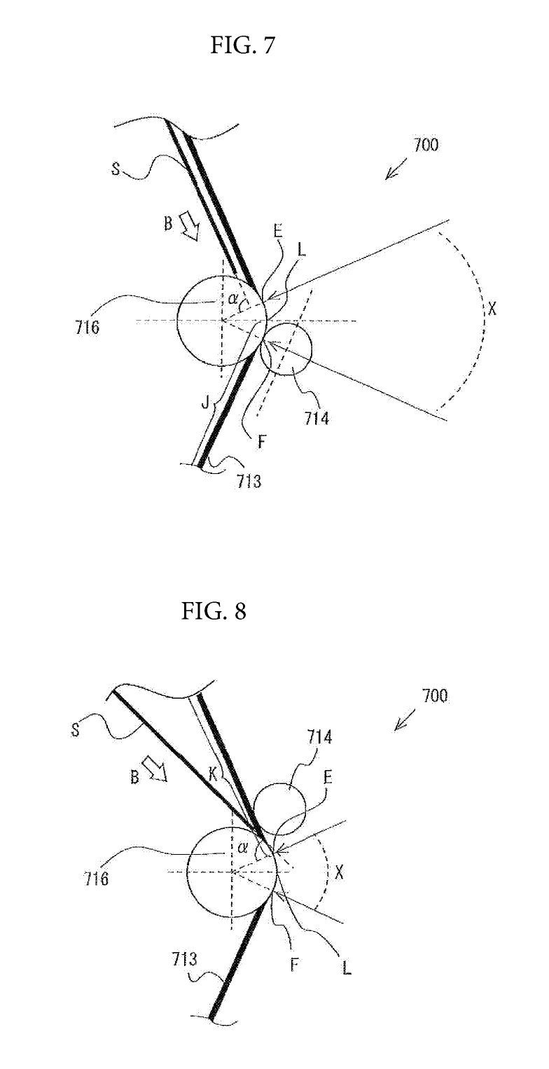

FIG. 7 is a view for briefly explaining the structure of the decurler 700 in accordance with the embodiment 4 of the present invention. As illustrated in FIG. 7, in the case where a sheet S is guided by the guide member 715 in order that the rush-in angle α is no smaller than 90°, the regulating member 714 is arranged in an area where the downstream area J and the winding area X overlap and in the most downstream position F.

Accordingly, the endless belt 713 is inhibited from being deformed by a sheet S in the upstream side of the most downstream position F along the conveying direction B of the sheet S. The most downstream position F is the most downstream position in the area where the pushing roller 716 makes contact with the endless belt 713. Thus, the endless belt 713 is inhibited from being separated from the pushing roller 716 by a sheet S in the contact area therebetween so that the force of correcting curl can be increased in accordance with the pushing amount of the pushing roller 716.

### Embodiment 5

In this embodiment 5, similar elements are given similar references as in the embodiments 1 through 4, and therefore no redundant description is repeated. In accordance with the embodiment 5, explanation is directed to an example in which the location of the regulating member 714 is different than in the embodiments 1 through 4.

FIG. 8 is a view for briefly explaining the structure of the decurler 700 in accordance with the embodiment 5 of the present invention. As illustrated in FIG. 8, in the case where a sheet S is guided by the guide member 715 in order that the rush-in angle α is smaller than 90°, the regulating member 714 is arranged in an upstream area K including contact points located in the upstream side of the reference position L along the conveying direction B of the sheet S among the contact points between the pushing roller 716 and the endless belt 713.

Accordingly, even if there is the possibility that the endless belt 713 is deformed by a sheet S in the upstream side thereof, the regulating member 714 can inhibit the endless belt 713 in advance from being deformed in the upstream side.

### Embodiment 6

In this embodiment 6, similar elements are given similar references as in the embodiments 1 through 5, and therefore no redundant description is repeated. In accordance with the embodiment 6, explanation is directed to an example in which the location of the regulating member 714 is more limited than in the embodiment 5.

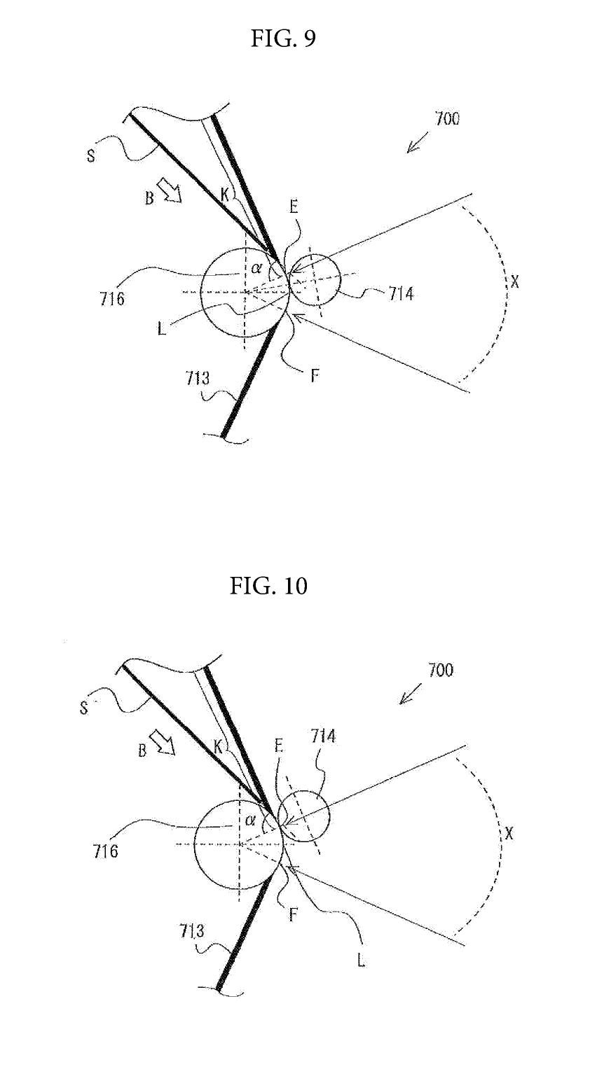

FIG. 9 is a view for briefly explaining the structure of the decurler 700 in accordance with the embodiment 6 of the present invention. As illustrated in FIG. 9, in the case where a sheet S is guided by the guide member 715 in order that the rush-in angle α is smaller than 90°, the regulating member 714 is arranged in an area where the upstream area K and the winding area X overlap.

Accordingly, the endless belt 713 is inhibited from being deformed by a sheet S in an area in the upstream side of the position in which the regulating member 714 makes contact with the endless belt 713 along the conveying direction B of the sheet S. The position in which the regulating member 714 makes contact with the endless belt 713 falls in an area where the upstream area K and the winding area X overlap. The winding area X is an area where part of the endless belt 713 is wound around the pushing roller 716. Accordingly, the endless belt 713 is inhibited from being deformed by a sheet S in the upstream side of part of the winding area X along the conveying direction B of the sheet S.

Thus, even when the pushing amount of the pushing roller 716 is increased, the force of correcting curl of the sheet S can be increased in the upstream side of the position in which the regulating member 714 makes contact with the endless belt 713.

### Embodiment 7

In this embodiment 7, similar elements are given similar references as in the embodiments 1 through 6, and therefore no redundant description is repeated. In accordance with the embodiment 7, explanation is directed to an example in which the location of the regulating member 714 is more limited than in the embodiment 6.

FIG. 10 is a view for briefly explaining the structure of the decurler 700 in accordance with the embodiment 7 of the present invention. As illustrated in FIG. 10, in the case where a sheet S is guided by the guide member 715 in order that the rush-in angle α is smaller than 90°, the regulating member 714 is arranged in an area where the upstream area K and the winding area X overlap and in the most upstream position E.

Accordingly, the endless belt 713 is inhibited from being deformed by a sheet S in the upstream side of the most upstream position E along the conveying direction B of the sheet S. The most upstream position E is the most upstream position in the area where the pushing roller 716 makes contact with the endless belt 713. Thus, the endless belt 713 is inhibited from being separated from the pushing roller 716 in the contact area therebetween so that the force of correcting curl can be increased in accordance with the pushing amount of the pushing roller 716.

### Embodiment 8

In this embodiment 8, similar elements are given similar references as in the embodiments 1 through 7, and therefore no redundant description is repeated. Explanation of the embodiment 8 is directed to the variation in the shape of the endless belt 713 curved by the pushing roller 716.

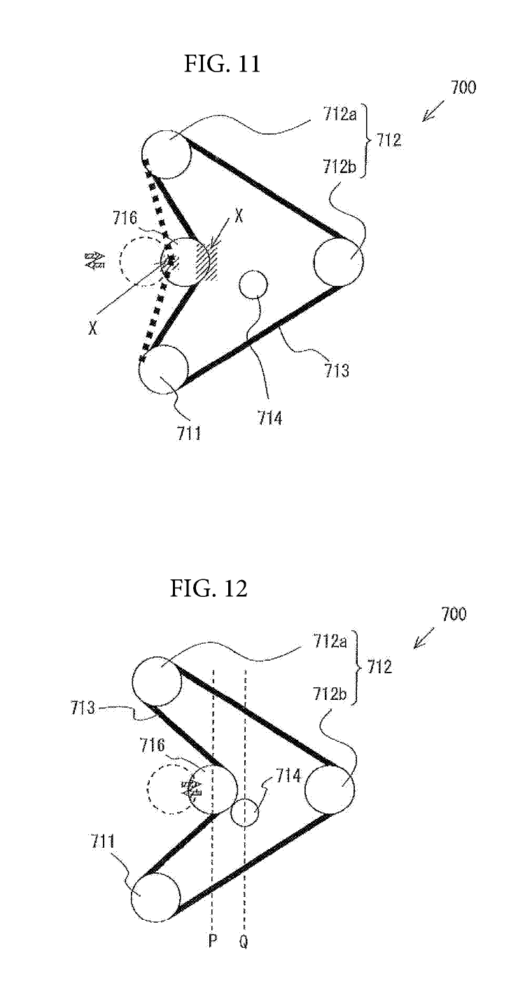

FIG. 11 is a view for briefly explaining the structure of the decurler 700 in accordance with the embodiment 8 of the present invention. The pushing roller 716 can variably push the outer peripheral surface of the endless belt 713.

Accordingly, as the pushing roller 716 pushes the endless belt 713, the pushing amount by which the pushing roller 716 pushes the endless belt 713 increases so that the winding area X increases. As the winding area X increases, the degree of curvature of the endless belt 713 increases so that the force of correcting curl of the sheet S can be increased. Hence, it is possible to make the force of correcting curl of the sheet S variable in accordance with the pushing amount of the pushing roller 716.

### Embodiment 9

In this embodiment 9, similar elements are given similar references as in the embodiments 1 through 8, and therefore no redundant description is repeated. In accordance with the embodiment 9, explanation is directed to an example of an positioning operation of the pushing roller 716 when the decurler 700 curls a sheet S.

FIG. 12 is a view for briefly explaining the structure of the decurler 700 in accordance with the embodiment 9 of the present invention. As illustrated in FIG. 12, the regulating member 714 is arranged in a standby position Q opposite to a stop position P in which the pushing roller 716 is to stop after being pushed. The stop position P is set, for example, in relation to the center of the pushing roller 716. The standby position Q is set, for example, in relation to the center of the regulating member 714. When correcting curl of the sheet S, the pushing roller 716 pushes the endless belt 713 to a position in which the endless belt 713 makes contact with the regulating member 714.

Therefore, even if a sturdy sheet S rushes into the endless belt 713, since the endless belt 713 is supported by the regulating member 714, the endless belt 713 is prevented from being separated from the pushing roller 716 by the sheet S. Accordingly, the force of correcting curl of the sheet S can be surely maintained.

### Embodiment 10

In this embodiment 10, similar elements are given similar references as in the embodiments 1 through 9, and therefore no redundant description is repeated. In accordance with the embodiment 10, explanation is directed to an example in which the shape of the regulating member 714 differs from that of the embodiments 1 through 9.

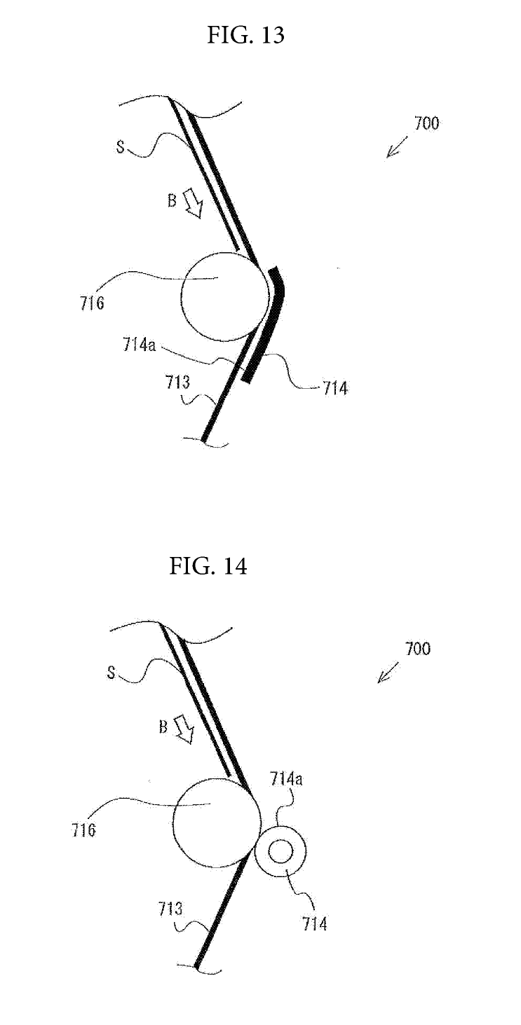

FIG. 13 is a view for briefly explaining the structure of the decurler 700 in accordance with the embodiment 10 of the present invention. As illustrated in FIG. 13, the regulating member 714 is a fixed member. The fixed member provides a contact surface 714a which makes contact with the inner peripheral surface of the endless belt 713.

The regulating member 714 can thereby hold the endless belt 713 over a wide area at a low cost.

### Embodiment 11

In this embodiment 11, similar elements are given similar references as in the embodiments 1 through 10, and therefore no redundant description is repeated. In accordance with the embodiment 11, explanation is directed to an actual example of the shape of the regulating member 714 which can be used in the embodiments 1 through 9.

FIG. 14 is a view for briefly explaining the structure of the decurler 700 in accordance with the embodiment 11 of the present invention. As illustrated in FIG. 14, the regulating member 714 is at least one of a drive rotation roller and a driven rotation roller which is rotationally driven by the drive rotation roller. Each of the rotation roller and the driven rotation roller provides a cylindrical contact surface 714a which makes contact with the inner peripheral surface of the endless belt 713 to form a nip. Meanwhile, in an example shown in FIG. 14, the regulating member 714 is a shaft member as a cylindrical member. In this case, the shaft member may be a drive rotation roller or a driven rotation roller.

The regulating member 714 can thereby be rotated together with the endless belt 713, so that there hardly occur a burden which would otherwise occur due to friction between the regulating member 714 and the endless belt 713.

### Embodiment 12

In this embodiment 12, similar elements are given similar references as in the embodiments 1 through 11, and therefore no redundant description is repeated. In accordance with the embodiment 12, explanation is directed to an operation example for adjusting the relative positional relationship among the regulating member 714, the endless belt 713 and the pushing roller 716 by adjusting the position of the pushing roller 716 and the position of the regulating member 714

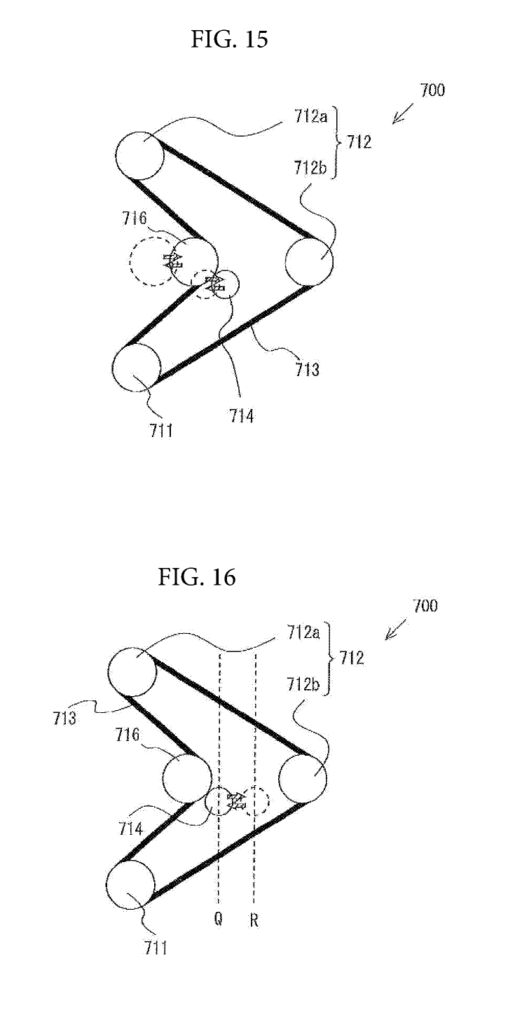

FIG. 15 is a view for briefly explaining the structure of the decurler 700 in accordance with the embodiment 12 of the present invention. As illustrated in FIG. 15, the regulating member 714 follows the positional displacement of the pushing roller 716 to change the relative positional relationship between the endless belt 713 and the pushing roller 716.

Accordingly, it is possible to always adjust the relative positions among the regulating member 714, the endless belt 713 and the pushing roller 716 to appropriate positions.

### Embodiment 13

In this embodiment 13, similar elements are given similar references as in the embodiments 1 through 12, and therefore no redundant description is repeated. In accordance with the embodiment 13, explanation is directed to an operation example for adjusting the relative positional relationship among the regulating member 714, the endless belt 713 and the pushing roller 716 in accordance with information about the paper type or paper density of a sheet S.

FIG. 16 is a view for briefly explaining the structure of the decurler 700 in accordance with the embodiment 13 of the present invention. As illustrated in FIG. 16, the regulating member 714 is arranged in a position separated from the inner peripheral surface of the endless belt 713 in accordance with information about the paper type or paper density of a sheet S. Specifically, if a sheet S is not so sturdy, the regulating member 714 is arranged in a standby position R. Conversely, if a sheet S is sturdy, the regulating member 714 is arranged in a standby position Q. The standby position Q is set, for example, in relation to the center of the regulating member 714 as well as the standby position R. Incidentally, the standby position R is not limited to a particular position as long as the regulating member 714 does not make contact with the inner peripheral surface of the endless belt 713.

As described above, in the case where a sheet S is of such a paper type or has such a paper density that the sheet S is not so sturdy, there is no fear that the endless belt 713 is deformed, and therefore the regulating member 714 need not hold the endless belt 713. In this case, therefore, the regulating member 714 places no load on the endless belt 713 by separating the regulating member 714 from the endless belt 713 so that it is possible to improve the efficiency of the entire system.

### Embodiment 14

In this embodiment 14, similar elements are given similar references as in the embodiments 1 through 13, and therefore no redundant description is repeated. In accordance with the embodiment 14, explanation is directed to an operation example for adjusting the force of correcting curl formed of a sheet S by adjusting the position of the regulating member 714.

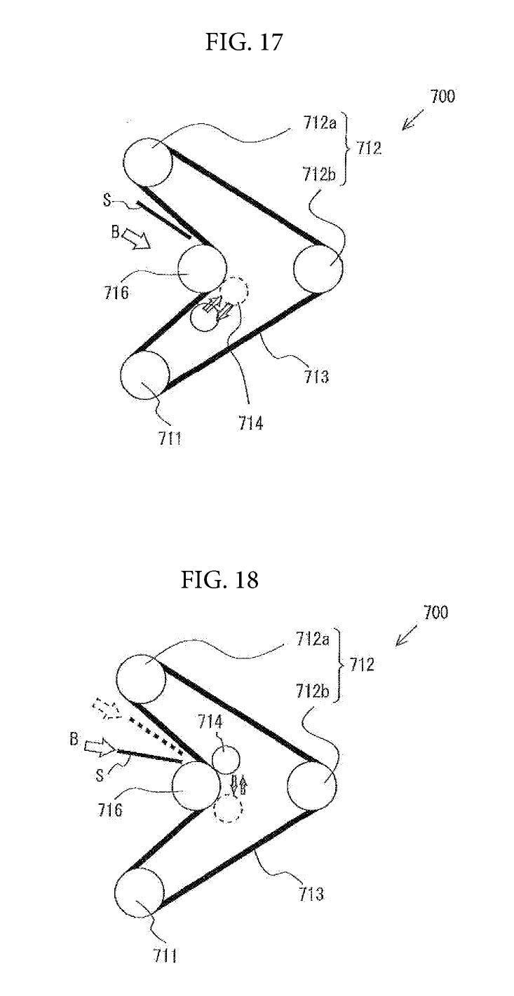

FIG. 17 is a view for briefly explaining the structure of the decurler 700 in accordance with the embodiment 14 of the present invention. As illustrated in FIG. 17, when the force of correcting curl formed of a sheet S is adjusted, the position of the regulating member 714 is shifted along the endless belt 713 to either the downstream side or the upstream side from the position in which the regulating member 714 is currently arranged.

Since the force of supporting the endless belt 713 by the regulating member 714 is varied when the position of the regulating member 714 varies, the force of correcting curl can be finely adjusted by shifting the position of the regulating member 714.

### Embodiment 15

In this embodiment 15, similar elements are given similar references as in the embodiments 1 through 14, and therefore no redundant description is repeated. In accordance with the embodiment 15, explanation is directed to an operation example in which switching the rush-in angle α of a sheet S is synchronized with adjusting the arrangement position of the regulating member 714.

FIG. 18 is a view for briefly explaining the structure of the decurler 700 in accordance with the embodiment 15 of the present invention. As illustrated in FIG. 18, when the rush-in angle α of a sheet S is switched from the current rush-in angle α of the sheet S to any one of predetermined rush-in angles α, the relative positional relationship among the regulating member 714, the endless belt 713 and the pushing roller 716 is changed with reference to the setting table 112a. The setting table 112a is a table in which is defined the relative positional relationship among the regulating member 714, the endless belt 713 and the pushing roller 716 for each rush-in angle α of a sheet S.

Accordingly, the decurler 700 can change the position of the regulating member 714 to an appropriate position in accordance with the rush-in angle α of a sheet S after switching.

### Embodiment 16

In this embodiment 16, similar elements are given similar references as in the embodiments 1 through 15, and therefore no redundant description is repeated. In accordance with the embodiment 16, explanation is directed to an example in which there are provided a plurality of members each of which serves as the regulating member 714.

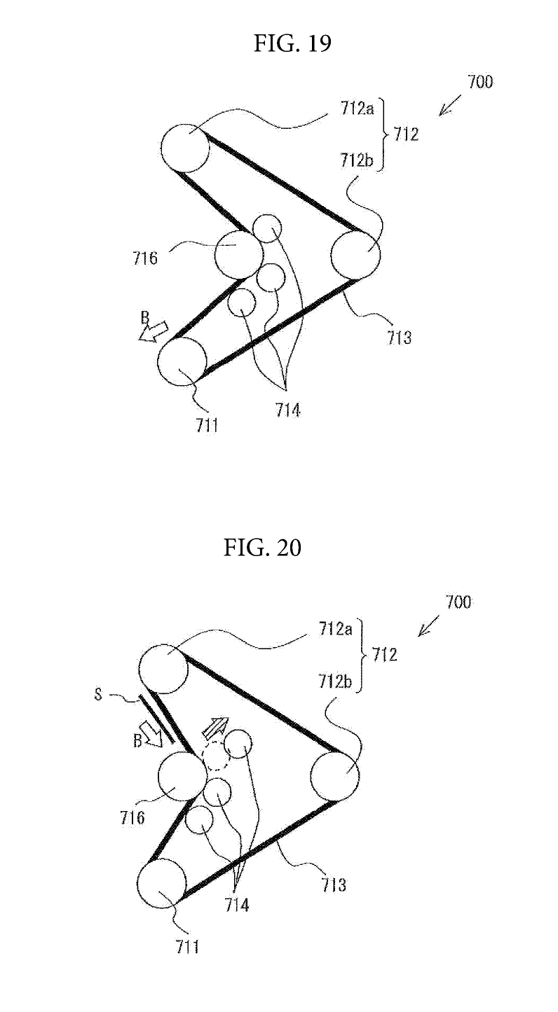

FIG. 19 is a view for briefly explaining the structure of the decurler 700 in accordance with the embodiment 16 of the present invention. As illustrated in FIG. 19, the regulating member 714 is arranged in at least two locations selected from among the downstream area J, the upstream area K, the winding area X, the most downstream position F and the most upstream position E. Namely, the regulating member 714 is arranged in at least two locations of the inner peripheral surface of the endless belt 713.

Accordingly, since the plurality of regulating members 714 support the endless belt 713, it is possible to further improve the function to support the shape of the endless belt 713.

### Embodiment 17

In this embodiment 17, similar elements are given similar references as in the embodiments 1 through 16, and therefore no redundant description is repeated. In accordance with the embodiment 17, explanation is directed to an example for improving the efficiency of the entire system in the case where there are provided a plurality of members each of which serves as the regulating member 714.

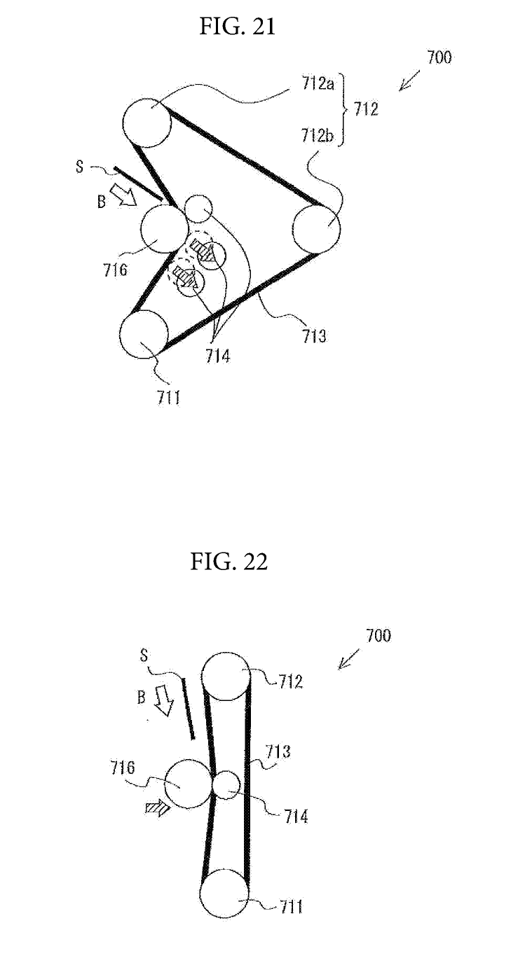

FIG. 20 is a view for briefly explaining the situation in which a sheet S rushes into the endless belt 713 at a rush-in angle α of no smaller than 90° in the decurler 700 in accordance with the embodiment 17 of the present invention. FIG. 21 is a view for briefly explaining the situation in which a sheet S rushes into the endless belt 713 at a rush-in angle α of smaller than 90° in the decurler 700 in accordance with the embodiment 17 of the present invention.

As illustrated in FIG. 20, if the rush-in angle α of a sheet S is no smaller than 90°, there is a fear that the endless belt 713 is deformed in the downstream side of the pushing roller 716, and there is no fear that the endless belt 713 is deformed in the upstream side of the pushing roller 716. Accordingly, in this case, the regulating member 714 located in the upstream side of the pushing roller 716 need not support the endless belt 713, and can be moved to a position separated from the endless belt 713.

On the other hand, as illustrated in FIG. 21, if the rush-in angle α of a sheet S is smaller than 90°, there is a fear that the endless belt 713 is deformed in the upstream side of the pushing roller 716, and there is no fear that the endless belt 713 is deformed in the downstream side of the pushing roller 716. In this case, therefore, the regulating member 714 located in the downstream side of the pushing roller 716 need not support the endless belt 713, and can be moved to a position separated from the endless belt 713.

In other words, of the regulating members 714 arranged in the inner peripheral surface of the endless belt 713, some regulating member(s) 714 is determined to be separated from the endless belt 713 in accordance with the rush-in angle α of a sheet S. The regulating member 714 can therefore be arranged only in necessary positions so that it is possible to improve the efficiency as the entire system.

### Embodiment 18

In this embodiment 18, similar elements are given similar references as in the embodiments 1 through 17, and therefore no redundant description is repeated. In accordance with the embodiment 18, explanation is directed to a modified example of the decurler 700 having a different number of the driven rollers 712.

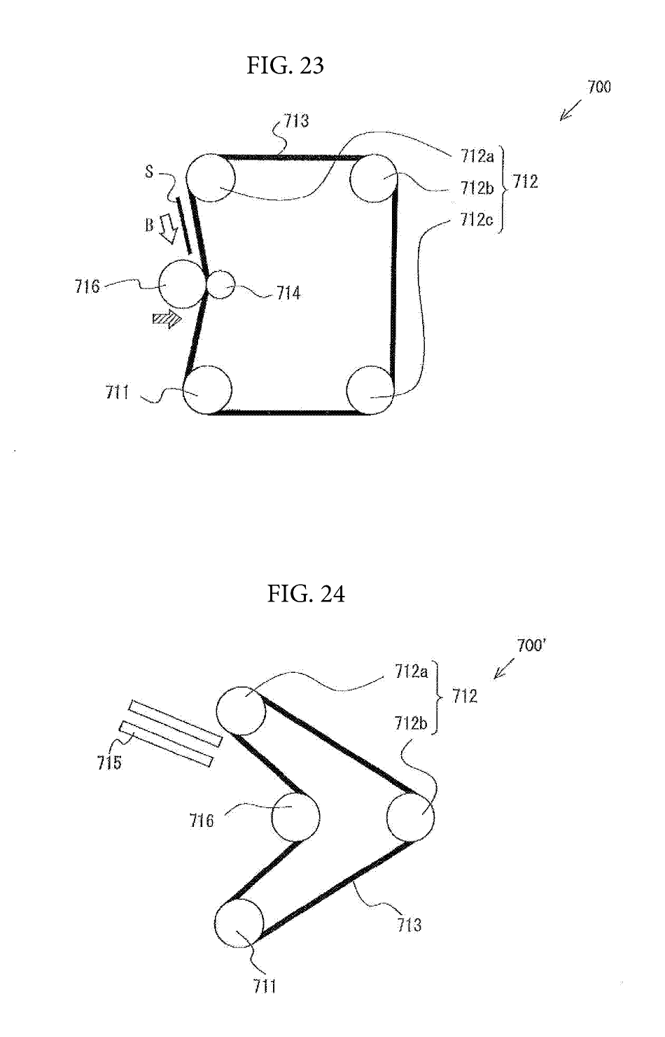

FIG. 22 is a view for briefly explaining the structure of the decurler 700 in accordance with the embodiment 18 of the present invention. FIG. 23 is a view for briefly explaining another structure of the decurler 700 in accordance with the embodiment 18 of the present invention.

As illustrated in FIG. 22, the decurler 700 is provided with only one driven roller 712 which follows the drive roller 711. In this case, as compared with the decurler having two driven rollers 712, while the degree of curvature of the endless belt 713 formed by the pushing roller 716 decreases, the system as a whole can be made compact.

On the other hand, as illustrated in FIG. 23, the decurler 700 is provided with three driven rollers 712 which follow the drive roller 711. In this case, as compared with the decurler having two driven rollers 712, while the system become large as a whole, the endless belt 713 is supported by four rollers, i.e., the driven rollers 712a, 712b and 712c and the drive roller 711 so that the area inside of the inner peripheral surface of the endless belt 713 can be widen. Accordingly, since the stop position P of the pushing roller 716 can be more distant from the endless belt 713, the degree of curvature of the endless belt 713 can be increased.

As described above, one or more driven rollers 712 are arranged. Namely, as long as the pushing roller 716 is pushed into the endless belt 713 and the regulating member 714 can support the endless belt 713 which is pushed by the pushing roller 716, a sheet S can be deformed in a desired shape so that the number of the driven rollers 712 is not particularly limited to realize various types of the decurler 700.

Accordingly, the decurler 700 can be arranged in a various space by determining the shape of the endless belt 713 in accordance with the number of the driven rollers 712 and the arrangement locations thereof

Also, since the area in the inner peripheral surface of the endless belt 713 can be widen by increasing the number of the driven rollers 712, the degree of curvature of the endless belt 713 can be increased as described above. The force of correcting curl formed of a sheet S can thereby be increased by increasing the number of the driven rollers 712.

The image forming system 1 have been explained based on the embodiments in accordance with the present invention. However, it is not intended to limit the present invention to the precise form described, and obviously many modifications and variations are possible without departing from the spirit and scope of the invention.

For example, while the image forming system 1 of the present embodiment is provided with the image forming apparatus 2 and the sheet finisher 7, the present invention is not limited thereto. For example, the image forming system 1 may be provided with a discharge unit capable of performing a folding process or an image reading apparatus capable of colorimetrically measuring an image of a sheet S.

Also, while the endless belt 713 is deformed in a curved shape by pushing the endless belt 713 with the pushing roller 716 in the case of the present embodiment, the present invention is not limited thereto, but a shaft member can be used as a member for pushing the endless belt 713. Namely, any member can be used as long as it provides a curved surface capable of deforming the endless belt 713 in a curved shape.

Incidentally, the structure of the embodiment 8, in which the pushing roller 716 can variably push the outer peripheral surface of the endless belt 713, can be applied to each, part or combination of the structures of the decurlers 700 as described in the embodiments of 1 to 7 and 9 to 18.

Also, the structure of the embodiment 18, in which one or more than two driven rollers 712 are provided, can be applied to each, part or combination of the structures of the decurlers 700 as described in the embodiments of 1 to 7 and 9 to 18.

Although embodiments of the present invention have been described and illustrated in detail, it is clearly understood that the same is by way of illustration and example only and not limitation, the scope of the present invention should be interpreted by terms of the appended claims.

What is claimed is:

1. A decurler comprising:
a drive roller;
a driven roller which rotates to follow rotation of the drive roller;
an endless belt which is wound around the drive roller and the driven roller; and
a pushing roller which is pushed into an outer peripheral surface of the endless belt,
wherein
curl formed of a sheet is corrected by passing the sheet between the endless belt and the pushing roller, the decurler further comprising:
a guide member which guides the sheet to the endless belt; and
a regulating member located in an inner peripheral side of the endless belt to hold, within a correcting force effective area, the endless belt which is deformed by the sheet which is guided by the guide member, wherein
the regulating member determines a relative positional relationship between the endless belt and the pushing roller based on the position of the pushing roller and the form of the endless belt which is deformed by a sheet.

2. The decurler of claim 1 wherein
the relative positional relationship is changed with the regulating member in accordance with the rush-in angle of a sheet which is guided by the guide member.

3. The decurler of claim 2 wherein
a most downstream position is a position in which the pushing roller makes contact with the endless belt in the most downstream point along the conveying direction of the sheet among the contact points between the pushing roller and the endless belt, wherein
a most upstream position is a position in which the pushing roller makes contact with the endless belt in the most upstream point along the conveying direction of the sheet among the contact points between the pushing roller and the endless belt, wherein
a reference position is a position corresponding to a midpoint between the most downstream position and the most upstream position, and wherein
when a sheet is guided by the guide member in order that the rush-in angle of the sheet is no smaller than 90°, the regulating member is arranged in a downstream area including contact points located in the downstream side of the reference position along the conveying direction of the sheet among the contact points between the pushing roller and the endless belt.

4. The decurler of claim 3 wherein
when a sheet is guided by the guide member in order that the rush-in angle of the sheet is smaller than 90°, the regulating member is arranged in an upstream area including contact points located in the upstream side of the reference position along the conveying direction of the sheet among the contact points between the pushing roller and the endless belt.

5. The decurler of claim 4 wherein
the rush-in angle of the sheet corresponds to the angle between the conveying direction of the sheet and the direction perpendicular to the contact point in the upstream side along the conveying direction of the sheet among the contact points between the pushing roller and the endless belt.

6. The decurler of claim 5 wherein
a winding area is an area where part of the endless belt is wound around the curved surface of the pushing roller, and wherein
when a sheet is guided by the guide member in order that the rush-in angle is no smaller than 90°, the regulating member is arranged in an area where the downstream area and the winding area overlap.

7. The decurler of claim 6 wherein
when the sheet is guided by the guide member in order that the rush-in angle of the sheet is no smaller than 90°, the regulating member is arranged in an area where the downstream area and the winding area overlap and in the most downstream position.

8. The decurler of claim 7 wherein
when the sheet is guided by the guide member in order that the rush-in angle of the sheet is smaller than 90°, the regulating member is arranged in an area where the upstream area and the winding area overlap.

9. The decurler of claim 8 wherein
when the sheet is guided by the guide member in order that the rush-in angle of the sheet is smaller than 90°, the regulating member is arranged in an area where the upstream area and the winding area overlap and in the most upstream position.

10. The decurler of claim 1 wherein
the pushing roller can variably push the outer peripheral surface of the endless belt.

11. The decurler of claim 10 wherein
the regulating member is arranged in a standby position opposite to a stop position in which the pushing roller 716 is to stop after being pushed, wherein
when correcting curl of the sheet, the pushing roller pushes the endless belt to a position in which the endless belt makes contact with the regulating member.

12. The decurler of claim 10 wherein
the regulating member is at least one of a fixed member, a drive rotation roller, and a driven rotation roller which is rotationally driven by the drive rotation roller, wherein
the fixed member is provided with a contact surface which makes contact with the inner peripheral surface of the endless belt, and wherein
each of the rotation roller and the driven rotation roller provides a cylindrical contact surface which makes contact with the inner peripheral surface of the endless belt to form a nip.

13. The decurler of claim 12 wherein
the regulating member follows the positional displacement of the pushing roller to change the relative positional relationship.

14. The decurler of claim 13 wherein
the regulating member is arranged in a position separated from the inner peripheral surface of the endless belt in accordance with information about the paper type or paper density of the sheet.

15. The decurler of claim 14 wherein
when a force of correcting curl formed of the sheet is adjusted, a position of the regulating member is shifted along the endless belt to either the downstream side or the upstream side from the position in which the regulating member is currently arranged.

16. The decurler of claim 15 further comprising:
a setting table in which is defined the relative positional relationship for each of predetermined rush-in angles of the sheet.
when the rush-in angle of a sheet is switched from the current rush-in angle of the sheet to any one of the predetermined rush-in angles of the sheet, the relative positional relationship is changed with reference to the setting table.

17. The decurler of claim 16 wherein
The regulating member is arranged in at least two locations in the inner peripheral side of the endless belt.

18. The decurler of claim 17 wherein
of the regulating members arranged in the inner peripheral surface of the endless belt, some regulating member(s) is determined to be separated from the endless belt in accordance with the rush-in angle of the sheet guided by the guide member.

19. A sheet finisher incorporating the decurler as recited in claim 1.

20. An image forming apparatus comprising:
an image forming block;
a sheet discharger which discharges a sheet, on which an image is formed by the image forming block, to the sheet finisher as recited in claim 19.
